(19) United States
(12) Patent Application Publication
(10) Pub. No.: US 2007/0156563 A1
(43) Pub. Date: Jul. 5, 2007

(54) Real Estate Derivative Securities and Method for Trading Them

(75) Inventor: Bradley J. McGill, Birmingham, AL (US)

Correspondence Address: MORGAN, LEWIS & BOCKIUS LLP, 1701 MARKET STREET, PHILADELPHIA, PA, 19103-2921, US

(73) Assignee: DRI, Birmingham, AL (US)

(21) Appl. No.: 11/686,107

(22) Filed: Mar. 14, 2007

Related U.S. Application Data
(63) Continuation of application No. 10/938,742, filed on Sep. 9, 2004.
(60) Provisional application No. 60/501,272, filed on Sep. 9, 2003.

(51) Int. Cl. G06Q 40/00

(52) U.S. Cl. 705/36 R

(57) ABSTRACT

A method for creating and marketing a commercial or residential real estate derivative instrument in the form of a structured note, future contract, or call or put option that provides a cash-settled payout to the buyer at a predetermined expiration date defined by the derivative instrument based upon the occurrence of a required change in value of a benchmark real estate index between a first, e.g., purchase date and the expiration date. The real estate derivatives instruments of the present invention may be used by property owners, developers, and financial institutions to hedge against a possible devaluation of their real estate assets. Institutional investors may use the derivative instruments to speculate in the value of commercial or residential real estate in order to broaden their investment portfolios.

### CROSS-REFERENCE TO RELATED APPLICATIONS

This application is a continuation of U.S. patent application Ser. No. 10/938,742, filed on Sep. 9, 2004, which claims the benefit of U.S. Provisional Application No. 60/501,272 filed on Sep. 9, 2003.

### FIELD OF THE INVENTION

The present invention relates to a method for using derivative securities to synthetically invest in real estate, or hedge against the risk inherent in the ownership of such real estate.

### BACKGROUND OF THE INVENTION

The value of real estate and land in the United States accounts for more than half of the national wealth. Commercial real estate in the United States is valued at $20 trillion. This is almost double the total market capitalization of the entire New York Stock Exchange (NYSE) ($11.6 trillion as of June 2004). Despite the sophistication of the financial markets in the U.S., however, there is still no secondary derivatives market in existence for this enormous asset class. At the same time, existing secondary derivative markets provide investors alternative methods for investing and hedging in virtually every other sizable asset class (e.g., the options market for equities, the futures market for commodities, and the treasuries markets for currencies.)

Real estate holdings can suffer from the risk of downward price movement. This fact can have an adverse effect upon the net worth of many companies and individuals who have significant portions of the assets accounted for by real estate holdings. This includes builders and developers of rental and other commercial properties, and owners of rental, industrial, and retail properties.

Another party impacted by downward movements in real estate prices is the banking industry, since the purchase of real estate is typically financed in substantial party by borrowed money. Banks will be adversely affected by defaulting borrowers. The only hedging mechanism that is really available to such lenders is financial futures or options contracts based upon interest rates, which are indirectly associated with real estate values.

Owners of real estate and mortgage lenders would benefit greatly from a financial instrument that would permit them to hedge this risk. Indeed, several economic professors published papers in the early 1990's identifying the need for such hedging instruments, and generally calling for the availability of cash-settled futures or options contracts based upon unspecified indices of real estate prices. See Case, Jr., K. E., Shiller, R. J., and Weiss, A. N., Index-Based Futures and Options Markets in Real Estate (December 1991); Shiller, R. J., and Weiss, A. N., “Home Equity Insurance,” NBER Working Paper Series, Working Paper No. 4830 (1994). Yet, ten years later, there still is no efficient method for hedging real estate. The only instance known to the inventors of any attempt to provide such a derivative security was a futures contract on residential real estate prices in the United Kingdom that was initiated by the London Futures and Options Exchange (London Fox) in May 1991. Trading in this contract was promptly suspended in October 1991, however, when it became apparent that few homeowners were availing themselves of an exchange-based system despite the presence of unstable residential real estate prices in England, and the exchange had artificially supported trading values in the futures contract to mask this deficit in customer usage.

In addition to providing an efficient hedging tool against tangible real estate investments, real estate derivatives would enable investors to synthetically invest in real estate. These investors may be interested in diversifying their institutional and individual portfolios to include real estate, which is not closely correlated to equities and many other investment vehicles, or they may be seeking to balance their real estate portfolio by investing in real estate in a disparate geographic region. To invest in real estate now, one must actually purchase the real estate. However, selling and buying real estate is an inherently inefficient and expensive process, making it exceedingly difficult for investors to efficiently invest capital in desirable real estate holdings. Furthermore, to truly diversify a commercial real estate investment portfolio, one would need to purchase different types of real estate in many different geographic markets, which would make the costs to execute such a real estate investment strategy exorbitant. Moreover, once purchased, such real estate holdings need to be maintained and managed, which can substantially further increase these costs.

Real estate investment trusts (REITs), which were created by Congress in 1960, are an existing option for those whose wish to invest capital in diverse real estate holdings. The concept of real estate investment companies dates back to the Old Dominion Land Corporation (N.J.) incorporated in 1880, and Alliance Realty (N.Y.) formed in 1899. REITs are intended to provide a diversified real estate portfolio.

Nevertheless, REITs and other real estate investment companies suffer from several problems that hinder true portfolio diversification. First, they do not allow investors control over the asset classes and geographic locations of the real estate holdings. Second, REITs expose the investor to management expenses. Third, REITs cannot invest in certain types of properties—most notably owner-occupied residential real estate and properties held by non-incorporated businesses. Fourth, it is noteworthy that REIT prices have been documented to be substantially correlated with the prices of shares in the stock market, which thereby obviates the strategy of diversifying an investment portfolio heavy in equity holdings. Fifth, because REIT real estate holdings are typically not geographically concentrated, they make for a poor hedging medium for an owner of commercial real estate in a particular geographic market who wants to obtain protection against adverse price movements within that market. What real estate owners truly desire is a financial instrument that will enable them to hedge against such a risk without needing to sell their property. A liquid real estate derivative would provide an efficient mechanism for creating this hedge.

Several types of securities are currently available to people or institutions, who want to speculate in the financial markets. These include financial futures contracts and exchange-based options.

A futures contract is an agreement from a buyer to accept delivery (or for a seller to make delivery) of a specific commodity, currency, or financial instrument for a predetermined price by a predetermined date. Most futures contracts are bought on speculation about future prices, and most futures traders are speculators, who do not expect to take delivery of the underlying product, because they purchase an offsetting futures contract prior to the expiration date of the first futures contract. Speculators intend to buy low and sell high to make a profit. Thus, they make money by accurately forecasting price movement. In futures markets, however, speculators not only need to forecast price movement, but also to predict when a price will be higher or lower. Owning a futures contract exposes the trader to theoretically unlimited risk if the position moves against him, and he is unable to close it out due to market circumstances. In addition, many retail traders cannot invest in futures contracts due to the significant net worth requirements for trading futures.

An option is a trading instrument that represents the right to buy (called a “call”) or sell (called a “put”) a specified amount of an underlying security at a predetermined price within a specified time period. The underlying security can be stocks, index funds, bonds, currencies, or futures contracts. The fixed price, or “strike price,” is the price at which the security underlying the option can be purchased or sold. It is important to note that, unlike for a futures contract, the option holder has no obligation to buy the underlying security.

The option purchaser pays a premium for the right, but not the obligation, to exercise the specifics of the option contract. An option is worthless after expiration, and the premium paid for the option cannot be recovered. The option seller assumes a legal obligation to fulfill the specifics of the contract if the option holder decides to exercise his right to buy. While the premium is the extent of the potential risk to the option buyer, the potential liability for the option seller is unlimited. The premium will be higher the longer the time period until expiration of the option, as the option has more time to move into the money (to reach the strike price), and to compensate the option seller for typing up the obligation on the security for the requisite time period.

Options can be used in a variety of ways to profit from a rise or fall in the market. Buying an option offers limited risk and unlimited profit potential. By purchasing the call option, the buyer hopes that the price of the underlying security will rise by the call's expiration, while the call option seller hopes that the price will decline or at least remain stable.

Selling an option, however, comes with an obligation to complete the trade if the party buying the option chooses to exercise the option. This therefore presents the seller with limited profit potential and significant risk unless the position is hedged in some manner. The put option buyer hopes that the price of the underlying security will drop before the expiration date, while the put option seller hopes that the price will rise or at least remain stable.

The strike price is the fixed price at which the security underlying the security can be purchased or sold at any time prior to the expiration date if the option is exercised by the option buyer. The option's expiration date designates the final date on which the option may be exercised. “American-style” options can be exercised at any time before the expiration, while “European-style” options can be exercised only on the expiration date. Exchange traded option have an expiration month, while American-style options expire on the third Saturday of the expiration month.

In view of the foregoing, it would be economically beneficial if liquid derivative instruments were available to real estate investors for all the same purposes and uses as futures and options in the commodities and equities markets. Such derivatives would allow investors to invest in real estate markets without having to actually purchase tangible real estate, and/or hedge their existing real estate holdings using appropriate derivatives.

### SUMMARY OF THE INVENTION

A method for creating, marketing, selling and cash settling a commercial or residential real estate derivative instrument is provided according to the invention. The derivative instrument may be created in the form of a structured note, a swap, a futures contract, or an option. It provides a cash-settled payout to the buyer at a predetermined expiration date defined by the derivative instrument based upon the occurrence of a required change in value of a benchmark real estate index between the purchase date, and the expiration date. The real estate derivatives of the present invention may be used by property owners, developers, and financial institutions to hedge against a possible devaluation of their real estate assets. Institutional investors may use the derivative instruments to speculate in the value of commercial or residential real estate in order to broaden their investment portfolios. By purchasing these derivatives, investors would receive a return comparable to returns of tangible real estate, effectively creating a way for investors to “synthetically” invest in real estate.

### BRIEF DESCRIPTION OF THE DRAWINGS

In the accompanying drawing:

FIG. 1 is a schematic showing the method of the invention for creating and marketing real estate derivatives as over-the-counter (OTC) derivatives.

FIG. 2 is a schematic showing the method of the invention for creating and marketing real estate derivatives as listed derivatives on an exchange.

### DETAILED DESCRIPTION OF THE PREFERRED EMBODIMENT

These and other objectives are achieved by the present invention, which provides for the use of structured notes, swaps, futures, or options contracts that are cash settled based on an index of commercial or residential real estate prices or some other factor impacting real estate. Such financial instruments will permit the real estate owner to hedge his tangible real estate properties against the inherent risk of a downward movement in the value of the property, while providing investors a genuine opportunity to diversify their investment portfolios by achieving “synthetic” ownership of real estate and many of the corresponding rights of property ownership without having to incur the high costs of actually buying and maintaining tangible real estate assets, or investing in a REIT.

For purposes of this application, “commercial real estate” means rental property like office buildings, strip malls, malls, multiple-family apartments, and single-occupancy rental dwellings; retail property like restaurants, operator-owned stores, and hotels; and industrial property like factories, plants, warehouses, and office showrooms.

For purposes of this application, “residential real estate” means owner-occupied residential dwellings, including but not limited to houses, townhouses, condominiums, owned apartments, and co-ops.

In the context of the present invention, a “real estate derivative” means a cash-settled structured note, swap, futures contract or a put or call option that is based on an underlying real estate index or data point that provides a composite value of the real estate of a relevant type in a germane geographic market.

“Synthetic ownership” of real estate means that the buyer of the real estate derivative may realize a financial return comparable to the ownership of real estate property without ever needing to actually purchase the property. Instead, the buyer will receive the comparable return on his or its investment in cash.

Until sufficient interest and thus liquidity is created in the marketplace for these real estate derivatives to trade efficiently on an exchange, the preferred method for trading the is a structured note sold on an OTC marketplace. An OTC market exists when a brokerage firm acts as a “matchmaker” to find a willing buyer or seller for a particular trade, This brokerage firm is called an OTC dealer, and they would act as independent credit support for both sides of the transaction where necessary to support liquidity and support the market's faith in the value of the derivatives. Moreover, the OTC dealer would step up to act as a seller or buyer in the even of insufficient liquidity for a particular trade.

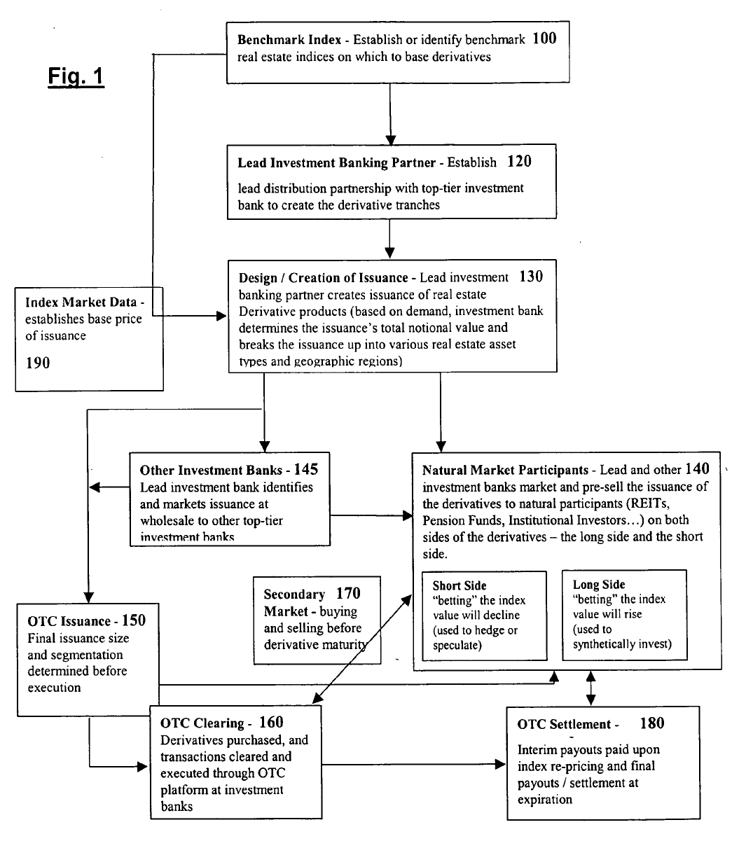

The method for developing a market for such OTC real estate derivatives is illustrated by the flow chart in FIG. 1. Step 100 involves the compilation of a benchmark index of pertinent real estate values. There are available data providers for commercial real estate, including the National Council of Real Estate Investment Fiduciary's (NCREIF”) National Property Index (“NPI”), CoStar, and the National Real Estate Index. Available data providers for the construction of a residential real estate index include HUD's extensive American House Survey (AHS), the Federated Housing Authority (FHA), or Case, Shiller, Weiss or similar property valuation company. Otherwise, a suitable index can be customized to fit the parameters of the particular commercial or residential real estate of interest. This could be done in conjunction with Standard & Poors or one of the other ratings agencies, or with investment banks like Credit Suisse First Boston who are experienced in creating indices, and who have expertise and credibility in the real estate ratings industry.

Typically, these indices will provide a composite value for a specific type of commercial property, such as “Class A” office space or multi-family apartments. For residential real estate, types of property covered by the index might include single-occupancy homes, townhouses, condominiums, or owned apartments. In addition, the property could be broken down by size in terms of value, total square feet, total rentable units, etc. Too broad of inclusion of property types may diminish the role of the index as an indicator of changes in property values. Moreover, the index may break up the commercial real estate property types on the basis of geography, such as a region of the country, a state, or a city or metropolitan area, In this manner, the index may be used to provide a clear and concise understanding of the changes in values, e.g., of “Class A office space in Northeastern U.S.” or “large multiple-family apartments on Southeastern U.S.” For residential real estate, the index will typically be geographically broken out on the basis of metropolitan area, zip code, township, or city.

However, investors may have reason to speculate in or hedge against changes in commercial real estate factors beyond mere changes in valuation. Its is also possible under this invention for the derivative to be predicated upon a sub set of the underlying index, such as an index based solely on rental rates, occupancy rates, vacancy rates, mortgage default rates, office employment growth, cap rates or absorption rates, and/or a combination of these factors. In addition, sub-indices could be based upon a combination of selected factors or even a single factor.

There are a number of considerations that should be taken into account in choosing or constructing an appropriate commercial or residential estate index that can provide a suitable basis for an underlying benchmark for a derivative instrument. First, the index obviously needs to include data points for the property type and geography region that is relevant to the commercial or residential real estate derivative instrument. Otherwise, the index will not serve its role as a determiner of the value of the derivative instrument. Second, the index should provide a credible representation of changes in the property values. Appraised values are often the most readily available property data on a broad basis, but data from the sale of actual real state property could be preferred. Third, the creator of the index must appropriately classify (i.e., Class A Office Space, Class B Office Space, etc.) the underlying real estate assets for the resulting complied data to have validity.

Fourth, the index should incorporate a larger number of underlying data points when calculating composite values. This is critical so that no smaller subset of buildings or property owners could, themselves, skew the entire index. This is particularly important given that the property owners will, in many cases, be supplying the data points that will be compiled into the index. If there was an insufficient breath of data points, a particular property owner supplying erroneous data could artificially inflate the index to enhance the value of their real estate derivatives. Fifth, the index must be re-priced on a sufficiently frequent basis to meet the needs of the derivative investors. Investors are obviously keenly interested in whether the value of their investment is increasing or decreasing. Thus, frequent re-pricing is necessary to inform investors about the current value of their investment. Yet, with regard to real estate where rental rates, vacancy rates, and property ownership can change on a relatively infrequent basis—typically, rental rates are locked in for at least a year, and investors hold commercial properties on average approximately five to seven years—adequate time must elapse to allow a significant number of events to occur to create a meaningful trend in the resulting compiled index value. Semi-annual or quarterly is preferred, with quarterly or more frequently being especially preferred. Sixth, the index must be accepted by the market as a valid measurement of underlying real estate values. It may therefore be better if the index is compiled by a well-known and recognized industry association.

For these reasons the preferred index for use in association with the commercial real estate derivatives of the present invention is NCREIF's NPI Index, which is recompiled and published on a quarterly basis. For residential real estate derivatives of the present invention, the preferred index is the “American Housing Survey” compiled and issued by the Department of Housing and Urban Development of the Federal Government.

Step 120 shown in FIG. 1 involves the establishment of a lead partner to distribute the real estate derivative products of the present invention. This distribution partner will typically be a top-tier investment bank because of their ready access to the financial markets, their superior expertise with creating and marketing financial derivatives; their large access to potential customers for the real estate derivatives products, and their capital inventories which could be utilized to provide credit support.

Step 130 of FIG. 1 entails the design and creation of the real estate derivatives to be sold in each OTC issuance of the instruments. There are numerous considerations to be taken into account when designing an issuance of OTC securities, including the total number and notional value of the derivatives, the characteristics and structure of the derivatives, the underlying index and its characteristics, the payout terms, and of course, the pricing. This complex process would typically be done by an established, top-tier investment bank.

In an OTC marketplace, the issued derivatives would typically consist of structured notes and swaps. For example, as part of an issuance of these real estate derivatives, an investment bank may decide to issue $100 million of structured notes with varying maturities on Class A office space in varying geographic locations. The investment bank would consider customer demand in determining a range for the total size of the issuance (in terms of national value), and the issuance would be divided into various real estate asset types and geographic regions. The real estate derivative product may be based on a desirable subset of real estate that investors want to invest in or hedge against. For example, “Class A office space in Northeastern U.S.”, “multiple family apartment in Southeastern U.S.”, retail malls in Southeastern U.S., hotel properties in New York or Las Vegas, industrial factories in the upper Midwestern U.S. The reader should appreciate that a potentially infinite number of possibilities exist for types of commercial or residential real estate to be covered by the derivative instruments of this invention. Anywhere that there exists a willing buyer and seller for investment in and hedging of risk for a particular type and location of real estate, a derivative instrument under this invention may be in demand.

The investment bank would also identify an expiration date for the various derivatives in the issuance. Numerous expirations are possible, but one to ten-year expiration would be common. Nevertheless, shorter or longer time periods are certainly possible. For instance, the developer of a building under construction may wish to purchase a derivative instrument with a six-month to one-year expiry to hedge against the risk of office building values decreasing in the market place while the building is under construction. If rental rates were to dramatically decline during the period, this would decrease the value of the index while increasing the value of the developer's short derivatives. Thus, upon expiration, the derivative would compensate the developer to help make up for the lower rental rates. Expiration dates beyond ten years, on the other hand, may be desirable for owners of buildings or tracts of land who are looking to match any payout under the derivative instrument to their anticipated sale date for their property.

Upon expiration, the structured notes would be cash-settled based on the performance of the underlying index. There are several different formats in which a payout under a commercial real estate derivative of the present invention might occur. First, the payout might take place at the time of expiration of the security to reflect the property value change as determined by the index. This approach would simply mimic the change in value of the index's underlying real estate during the elapsed time period.

An alternative approach would be to fashion the parameters of the derivative instrument such that interim income streams would be paid out each time the index is re-priced to reflect the appreciated or depreciated value of the property covered by the index. These scheduled payments are designed to enable the derivatives to closely resemble the stream of rent payments the owner of tangible real estate property would receive.

Still another possibility would be for the derivative instrument payouts to reflect a combination of these approaches, whereby the investor receives payments upon re-pricing of the index and a final payout at expiration of the derivative. This approach has the benefit of closely matching both the payment streams tangible real estate owners and investors receive from the rent payments and the property's valuation increase or decrease during the derivative's term. The idea would be for these derivatives to so closely correlate to actual ownership of the index's underlying real estate that they would create, in essence, a synthetic ownership of the same.

Any real estate derivative's price will take into account the term, the underlying index, the payout structure including the conditions for that payout, as well as the history of price movements in the relevant real estate type and geography, including volatility thereof, as reflected by the index. A derivative providing periodic payouts, particularly guaranteed interior-payouts to reflect rental income, would command a higher price. Of course, the price must attract a willing buyer and seller for the derivative as the success of the real estate derivatives products of the present invention depends upon an efficient two-way market that includes willing buyers of these securities.

Step 140 of the present invention shown in FIG. 1 illustrates the marketing and pre-selling of the real estate derivative products to “natural-selling participants” in the real estate derivatives markets. One example of a natural participant in commercial real estate markets is mortgage lenders who wish to hedge the credit risk in their portfolios. They are currently active in hedging interest rate risk on the financial markets, but have no effective mechanism to hedge against default exposure. There is a high inverse correlation between prices of commercial real estate and default rates. Other examples of natural participants on the selling, or short side of these derivatives, include major developers looking to offset systemic risk in existing or proposed projects, financial institutions carrying real estate exposure on their balance sheets, P&C insurers looking to manage property value risk exposure as part of their underwriting process, major commercial brokers interested in offering priced-protected future availability of space in rental properties to key tenants, REITs wishing to hedge their tangible real estate holdings or smooth their earnings by locking in entry to exit prices of major holdings or future purchases, and property owners who want to hedge against the risk of decreased values of their existing properties.

Step 140 of FIG. 1 also shows the marketing and pre-selling of the real estate derivative products to “natural-buying participants.” The natural participants on the buyer side could be REITs or any financial institution who wishes to invest capital in a strategic real estate asset class or geographic region, and would thus take a long position in real estate derivatives whose underlying index matches their desired asset class or geographic region. Additional long investors include pension plans and other asset allocating investors who desire exposure to the real estate asset class, but who prefer the liquidity of a derivative, or who cannot find physical property to buy in a reasonable period of time.

The invention of these real estate derivative products creates a way to provide the returns of real estate investment and ownership on a synthetic basis, and a way for financial institutions such as hedge funds and endowments to speculate on prices in the derivatives market, treating these real estate derivatives as a new trading opportunity in a unique class. Thus, investors and speculators taking a long position in these real estate derivatives could enjoy the benefits of “owning” the real estate market without the costs, illiquidity, and supply constraints of direct ownership, while hedgers who take a short position in these derivatives would enjoy the assurance provided by these instruments against a large loss in their underlying real estate value.

Step 145 of FIG. 1 demonstrates how the lead investment bank will also sell wholesale some of the derivatives to other leading investment banks. Doing this helps the lead investment bank to diversify its risk of finding a sufficient number of buyers (long participants) and sellers (short participants) of the instruments to create a viable market. The additional investment banks will also market and pre-sell the derivatives to their customers.

In Steps 150 and 160 of FIG. 1, the derivatives are actually issued and sold. Before the issuance, the lead investment bank will determine the final tranche size and segmentation based on customer demand during the marketing and pre-sell phase. Once the final issuance tranche size and segmentation are determined, the derivatives are sold to the customers, and the transactions are cleared through the investment bank's OTC clearing platform. The principal advantage of using an OTC platform at least in the initial stage of implementation of this invention is the product flexibility that an OTC platform provides. Using an OTC platform, the lead investment bank can customize the size and segmentation of the derivative issuance to meet customer demand. On an exchange, all the instruments are standardized, and thus lack this flexibility.

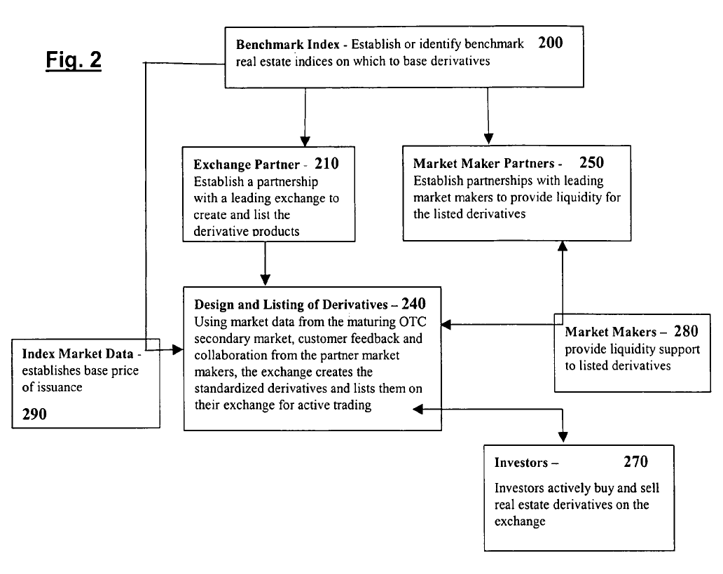

In Step 170 of FIG. 1, the owners of the original derivatives purchased at issuance can sell their derivatives before maturity through the investment bank's OTC processes. As the original purchasers sell their derivatives before maturity, a second market for the derivatives is created. As volume increases in the secondary market, the derivatives become widely dispersed and more liquid as additional customers become aware of their existence and learn how they can utilize them as part of their investment strategy. As the secondary market matures, trading volume and subsequently the liquidity of the derivatives will potentially rise to levels that justify standardizing the derivative contracts and listing them on an exchange as outlined in FIG. 2.

In Step 180 of FIG. 1, the investment banks settle the derivatives with the various owners at maturity according to the payment terms of the derivative. In addition, the investment banks will manage any interim payments owed to the owners of derivatives whose payout structure includes interim payments based on re-pricing of the underlying index.

The price transparency created by these real estate derivative transactions would have intrinsic value of providing real-time market data in a market place with fractured information. Thus, optional Step 190 shown in FIG. 1 entails use of this market data to further establish the benchmark indices of Step 100.

FIG. 2 illustrates the necessary steps for creating and marketing commercial or residential real estate derivatives for trading as listed contracts on a classic exchange. In Step 200, a benchmark real estate index is established in the same manner described above, making it sufficiently relevant to the property type and geographic region that will characterize the listed derivatives.

Next, Step 210 involves the establishment of a partnership with a leading exchange to list the commercial or residential real estate derivative product on their exchange. This could be, for example, the Chicago Board of Trade or Chicago Mercantile Exchange, which are large-volume trading exchanges for other types of financial and commodity-based derivatives. If the volume of the OTC secondary market (Step 170 of FIG. 1) was sufficient, then leading exchanges will be very interested in listing these derivatives.

This exchange partner will create the real estate derivative products, including any contract and trading specifications under Step 240 in the manner described above. The real estate derivatives of the present invention will be listed on the exchange in the same manner of the S&P 500 Equity Index Futures, Eurodollars, etc. The transactions for buying and selling the real estate derivatives products will be made and cleared on the exchange through the exchange's established clearing processes.

At the same time, a partnership needs to be established under Step 250 with one or more leading market makers to provide necessary liquidity to these trades conducted on the exchange. Investors will actively buy and sell the listed real estate derivatives on the exchanges, as shown under Step 270. The market makers will use their own capital under Step 280 to buy or sell real estate derivative products for their own accounts if there is insufficient demand on the buyer or seller side for the derivative products. In this manner, the market makers provide liquidity support for the listed real estate derivative products of the present invention.

The price transparency created by these actively traded listed real estate derivatives, would have intrinsic value in providing real-time market data in a market place with fractured information. Thus, optional Step 290 shown in FIG. 2 entails use of this market data to further establish the benchmark indices of Step 200.

The real estate derivative products described above have assumed that they will be based upon a single real estate asset type in a single geographic region. However, owners of or investors in two different types of real estate assets may have opposite viewpoints with respect to the price movements for these asset types. For example, Party A may believe that the value of Multi-Family Housing will increase, while the value of Class A Office Space will decrease, with Party B believing the opposite. In this case, the two parties could purchase offsetting positions in real estate derivative swaps with the same expiration date. Thus, such a real estate derivative swap is a single instrument combining two different real estate derivative positions in an offsetting manner. A large variety of other real estate derivative swap products are possible, including, e.g., a single property type (e.g., Class A Office Space) in two different geographic regions (e.g., Northeast vs. Southeast). Such real estate derivative swaps could also be based upon entire classes of real estate property assets, such as retail real estate vs. industrial or rental real estate.

Another possibility for the real estate derivatives of the present invention is timberland structured notes. Paper manufacturing companies and timber management companies dependent upon a reliable supply of trees. There is a risk of decrease in the value of such timberlands if, for example, a hurricane should strike, or the demand for paper substantially decreases in the marketplace. Thus, a real estate derivative for southeastern timberland could be made available that could be used to hedge against or synthetically invest in this risk.

The above specification, examples, and data provide a description of the invention relating to commercial real estate derivatives. Since many embodiments of the present invention can made without departing from the spirit and intended scope of the invention, the invention resides in the claims hereinafter appended.

We claim:

1. A method for creating and marketing a residential real estate derivative instrument, comprising the steps of:
(a) establishing or accessing a benchmark index that characterizes the value of a plurality of residential real estate properties of a particular type;
(b) establishing a residential real estate derivative instrument based upon the benchmark index for that particular type of real estate property having a first value at a first time, the derivative instrument having an expiration date, and defining a cash-settled payout based upon a change in the value of the index between the first time and the expiration date;
(c) indentifying a seller of the derivative instrument;
(d) indentifying a buyer of the derivative instrument;
(e) marketing the derivative instrument to the seller and buyer;
(f) selling the derivative through a distribution channel;
(g) clearing and executing the transaction for the derivative instrument through a marketplace structure; and
(h) settling the derivative instrument by making the cash-settled payout to the buyer based upon any change that has occurred in the value of the index between the first time and the expiration date.

2. The method of claim 1, wherein the residential real estate derivative instrument is a structured note.

3. The method of claim 1, wherein the residential real estate derivative instrument is a cash-settled call or put option.

4. The method of claim 1, wherein the residential real estate derivative instrument is a cash-settled futures contract.

5. The method of claim 1, wherein the property type is rental property.

6. The method of claim 1, wherein the property type is further defined by a geographic region.

7. The method of claim 1, wherein the expiration date is 1 month to 30 years after the first time of the residential real estate derivative.

8. The method of claim 1, wherein the benchmark index is the American Housing Survey.

9. The method of claim 1, wherein the payout consists of a single payout upon the expiration date to reflect the change in value of the index between the first time and the expiration date.

10. The method of claim 1, wherein the payout comprises a plurality of interim payments made to the buyer between the first time and the expiration date based upon the change in value of the index since the last interim payment, followed by a final payment at the expiration date based upon the change in value of the index between the first time and the expiration date.

11. The method of claim 1, wherein the distribution channel is an over-the-counter (“OTC”) dealer, and the marketplace structure is an OTC platform at an investment bank.

12. The method of claim 1, wherein the distribution channel is a securities broker, and the marketplace structure is a financial exchange.

13. The method of claim 1, wherein the seller is a residential property owner hedging against the risk of downward value in his property.

14. The method of claim 1, wherein the buyer is an individual or institutional investor.

15. The method of claim 1, further comprising generating market data through the derivatives transaction, which can be used to further the benchmark index.

16. The method of claim 1, further comprising the sale by the buyer of the derivative instrument before the expiration date on a secondary market.

17. A method of creating a derivative product for residential real estate, comprising:
(a) identifying a benchmark index that characterizes the value of a plurality of residential real estate properties of a particular type;
(b) identifying a derivative instrument based upon that particular type of residential real estate property having a first price corresponding to the value of the index at a first time;
(c) indentifying an expiry;
(d) indentifying a price to be paid by a buyer of the derivative instrument;
(e) clearing and executing a transaction for the derivative instrument through a market place structure; and
(f) wherein the derivative instrument is settled by making a cash-settled payout to the buyer defined by the sum of the first price and a further increment correlated by the derivative instrument to a change in value of the index between the first time and the expiry.

18. The method of claim 17, wherein the residential real estate derivative instrument is a structured note.

19. The method of claim 17, wherein the residential real estate derivative instrument is a cash-settled call or put option.

20. The method of claim 17, wherein the residential real estate derivative instrument is a cash-settled futures contract.

21. The method of claim 17, wherein the property type is rental property.

22. The method of claim 17, wherein the property type is further defined by a geographic region.

23. The method of claim 17, wherein the expiry is 1 month to 30 years after the first time of the residential real estate derivative.

24. The method of claim 17, wherein the benchmark index is the American Housing Survey.

25. The method of claim 17, wherein the payout consists of a single payout upon the expiration date to reflect the change in value of the index between the first time and the expiration date.

26. The method of claim 17, wherein the payout comprises a plurality of interim payments made to the buyer between the first time and the expiration date based upon the change in value of the index since the last interim payment, followed by a final payment at the expiration date based upon the change in value of the index between the first time and the expiration date.

27. The method of claim 17, wherein the residential real estate derivative transaction is cleared and executed through an “OTC” platform at an investment bank.

28. The method of claim 17, wherein the residential real estate derivative transaction is cleared and executed through a financial exchange.

29. The method of claim 17, wherein the buyer is a residential property owner hedging against the risk of downward value in his property.

30. The method of claim 17, wherein the buyer is an individual or institutional investor.

31. The method of claim 17, further comprising generating market data through the derivatives transaction, which can be used to further establish the benchmark index.

32. The method of claim 17, further comprising the sale by the buyer of the derivative instrument before the expiration date on a secondary market.
